(19) United States
(12) Patent Application Publication
(10) Pub. No.: US 2003/0229590 A1
(43) Pub. Date: Dec. 11, 2003

(54) Global integrated payment system

(76) Inventors: Shannon Lee Byrne, Whistler (CA); Andrew Patterson, Whistler (CA)

Correspondence Address: Roylance, Abrams, Berdo & Goodman, L.L.P., Attn: Stacey J. Longanecker, 1300 19th Street, N.W., Washington, DC, 20036, US

(21) Appl. No.: 10/317,218

(22) Filed: Dec. 12, 2002

Related U.S. Application Data
(60) Provisional application No. 60/339,302, filed on Dec. 12, 2001.

(51) Int. Cl. G06F 17/60

(52) U.S. Cl. 705/40

(57) ABSTRACT

A system and method are provided for Internet payment enablement and support for merchants and acquirers or other financial institutions (FIs). The system accommodates different payment transactions and channels between customers and merchants, and between merchants and their FIs. A payment transaction manager (PTM) securely routes payment transactions from merchants via the system back-end to different FIs. The PTM accepts any payment transaction, from any device, using any protocol. The system provides merchants with a single integrated interface to their FIs, aggregated transaction data, and merchant enablement tools such as a Merchant Integrated Kit (MIK) to support different payment channels between customers and merchants via plugs, cartridges and hosted pay pages, and a Merchant Support Center for accessing and managing stored electronic transaction data. The system also provides merchant-facing products with Internet payment, virtual terminal, billing, point of sale and wireless solutions.

This application claims the benefit of U.S. provisional application Serial No. 60/339,302, filed Dec. 12, 2001, the entire contents of which is hereby incorporated herein by reference.

### FIELD OF THE INVENTION

The present invention relates to a system for Internet payment enablement and support for merchants, as well as for banks, acquirers and other financial institutions. The system accommodates different payment types, channels and commence applications between customers and merchants and between merchants and their financial institutions, is relatively simple to install, and provides seamless processing of payment transactions with respect to the merchant regardless of the commerce application(s) and financial institution(s) used.

### BACKGROUND OF THE INVENTION

With reference to FIG. 1, consumers or buyers 20 purchase goods and services from sellers or merchants 22 using any of a number of different payment channels and payment types. The payment channels 18 can be, for example, a point of sale (POS) 24 (e.g., a customer visits a merchant's physical store location and conducts a brick and mortar transaction via a swipe terminal), a call center POS 26 (e.g., a customer places a telephone order), via mail order 27, web-based payment processing 28, wireless-based payment processing 30, an interactive television transaction, batch payment processing, Customer Relationship Management (CRM) processing, Enterprise Resource Planning (ERP) processing, or an accounting transaction, among others. The payment types can be, but are not limited to, payment by cash 32, check 34, credit or debit card 36, electronic funds transfer 38 or other electronic payment types such as a smart card, PCard, B2B Non card, LOC.

In addition to conducting transactions with customers or buyers 20, sellers or merchants 22 need to conduct transactions with suppliers 40 and financial institutions (FIs) 42 such as processors, banks and acquirers who can perform any of acquiring, issuing, processing and bank depositing services. Merchant acquirers 42 allow merchants 22 to send credit card data, debit card data and other electronic transaction data to the merchant acquirer. The merchant acquirer 42 gives merchants 22 accounts to collect these types of transactions. Examples of merchant acquirers are Moneris Solutions or Toronto Dominion in Canada, or U.S. Bank, Fifth Third and Nova Information Systems in the United States.

By way of an example, transactions are sent by a merchant 22 to one or more FIs 42 via any of a number of channels 18 such as a wireless service provider, an Internet service provider, telephone lines and leased lines, among others. Merchants are required to format data from buyer transactions into different formats to accommodate the channel and format used to communicate with the various FIs 42. Merchants 22 typically have a 30-60 day cycle for follow-on transaction processing. Merchants typically have to manually format after-processing transaction data into a format that may be useful for management purposes. A need therefore exists for an integrated and complete tool kit that offers merchants a range of connections and simple instructions and support to make establishment and certification of payment transaction connections easy for the merchant 22, as well as for the FI(s) 42 the merchant uses. A need also exists for an integrated payment system that aggregates transactions from all channels, and stores aggregated transaction data for easy access and decision-making.

FIG. 1 highlights some of the factors that impact a seller's ability to conduct business, that is, the operations that sellers' commerce systems must be able to perform such as support buyers that are located around the world, interact with a global supplier base, interface with many financial organizations worldwide, accept many currencies 46, accept multiple payment types (credit cards, checks, letters of credit, ACH, EFT, and so on), utilize a multi-interface approach (e.g., including retail POS storefronts, call centers, mail order, mobile and wireless devices, web sites and interactive television) between buyers 20 and sellers 22, integrate many business applications, associate the movement and delivery of goods with the flow of money and the flow of transaction information, and provide detailed and integrated information about all transactions.

Although this is what a seller 22 needs its commerce system to do, a seller faces a number of challenges in achieving this objective. Existing payment processing systems are complex, inefficient, slow, costly, lacking in global solutions, unable to aggregate information, lacking in decision support tools, lacking in common standards, lacking in security and customer trust, lacking in support for the seller, and provide fragmented rather than complete solutions. Accordingly, merchants 22 need not one way, but many ways, to connect to FIs 42. They need connections that work with their commerce applications, and they generally have more than one commerce application. Different payment technologies have been developed. For example, payment engines have been developed for merchants 22 to process credit card transactions using a specific protocol (e.g., SET and STT, Verified By VISA). Merchants, however, need other commerce applications to implement different credit card processing protocols, as well as other types of payment methods, which makes their payment transaction processing complex and expensive. Simple COM and Java plugs do not provide a solution. Supporting and certifying the connection to FIs 42 is time consuming and demanding of skilled technical personnel and other resources.

Banks and financial organizations 42 also face a number of challenges in providing the complete range of electronic payment solutions that sellers 22 demand. For example, existing legacy systems within banks do not easily integrate with Internet technology. The technology that supports electronic payments changes rapidly. Thus, technical resources within financial organizations are often overextended and insufficient time exists to adopt emerging technologies. For processor acquirers, supporting and certifying the connection of merchants is time consuming and demanding of skilled technical personnel and other resources, even if all the merchants' needs were the same and they are not in most cases. Supporting each merchant after the sale with technical support can also be demanding of technical resources. Selling and supporting the implementation of electronic payments solutions to sellers requires a distinct capability set which may not exist within the financial organization. Further, smaller financial organizations 42 may lack the scale efficiency to build solutions cost effectively on their own.

A need exists for a global integrated payment system that meets the needs of the seller 22 and the seller's bank or other FIs 42. A need also exists for an integrated payment system that uses to its advantage the technological infrastructure, roles and needs of the other key players in the payment value chain, and the formation of key relationships, to bring the solutions to market effectively. A need exists for a payment platform that can incorporate new technologies to provide a secure, reliable and flexible payment transaction processing solution for financial organizations 42 and the sellers 22 that they serve to reduce risk and improve profitability for those financial organizations that adopt it.

### SUMMARY OF THE INVENTION

In accordance with the present invention, a global integrated payment system is provided to accommodate all sizes of merchants (i.e., from small merchants to large enterprises) to facilitate the establishment, operation and management of their respective payment systems, including their transactions with their customers and their financial institutions (FIs). The global integrated payment system of the present invention also assists FIs with implementing core payment technologies to process and manage payment transaction data from sellers or merchants, as well as provides activity, sales and marketing support to enable FIs to offer payment services to sellers or merchants. The system is scaleable, flexible, easy-to-use, comprises the best technologies and partners, and designed to help sellers and the FIs that serve them to enable and manage global commerce. The system provides a certified and reliable connection between merchants and their processor/acquirers' gateways. The system provides a large portfolio of proven cartridges, APIs and other merchant tools to make it easy for merchants to integrate the payment solutions of their financial institutions.

In accordance with an aspect of the present invention, the global integrated payment system comprises a payment transaction manager (PTM) to aggregate the processing needed for supporting any payment transaction, from any device, using any protocol. The global integrated payment system of the present invention gives merchants one interface to send all payment transactions to the PTM. The system, in turn, operates with the leased lines, the Internet, the wireless links, and other links needed to communicate with the different FIs and works with the components of the various service providers needed for such communications. The system also supports different protocols used by the FIs.

In accordance with another aspect of the present invention, merchant tools are provided by the global integrated payment system such as a merchant home page and a Merchant Integration Kit (MIK) to provide a detailed catalogue and portfolio of solutions and instructions and resources to implement a selected payment solution, as well as a Merchant Support Center (MSC). The MSC is a business management tool merchants can use to manage electronic payments on a daily basis if desired, to access to transaction information and to conduct basic processes such as closing batches and running reports. The global integrated payment system aggregates transaction data to allow the import and export of transaction data to and from accounting and cash management systems.

The Merchant Integration Kit (MIK) is a tool that sellers can use to enable their electronic commerce platform. This toolkit provides the sellers with the information they need to make choices about the solution that will best meet their needs. The toolkit is user-friendly with simple point-and-click solutions, detailed instructions and resources needed by sellers and by the development community that serves them. The global integrated payment system has an extensive portfolio of custom payment cartridges designed for the most popular commerce applications. The MIK supports a range of different connections and provides simple instructions to facilitate merchants making connections. The MIK is particularly useful when a merchant needs many different connections to its customers and FIs. The MIK works with a merchant's commerce applications and surpasses the use of simple Java and COM plugs that often do not support the connections.

The Merchant Support Center (MSC) is the tool that sellers can use on an ongoing basis once they have enabled themselves to conduct electronic transactions. The MSC is a database that stores the sellers' electronic transaction data and allows the seller to manage their business. The seller can review transactions, issue voids and refunds, close batches and monitor their electronic receipts. The MSC provides merchants with reporting and reconciliation tools to improve their operational efficiency while providing better data for decision-making.

The integrated payment platform of the present invention uses different commerce applications to process different payment channels and payment types. In accordance with yet another aspect of the present invention, the global integrated payment system provides a portfolio of solutions to merchants. A number of merchant-facing products are provided such as: Internet payment solutions designed to help merchants accept electronic payments from an online storefront, virtual terminal solutions designed to meet the electronic payment needs of call centers, trade shows and traveling sales people or replace credit/debit card terminals used in storefronts for face-to-face transactions, biller solutions designed to present bills electronically and/or collect recurring payments, POS solutions designed for retail merchants with face-to-face customer interaction to use the Internet to process transactions quickly and efficiently, wireless payment solutions to accept payments through devices such as personal digital assistants, or mobile telephones, and an integrated platform payment solution to support multiple interfaces for completing a transaction for a large multi-channel/multi-location merchant with, for example, a website, multiple retail storefronts, and a call center.

### BRIEF DESCRIPTION OF THE DRAWINGS

The various aspects, advantages and novel features of the present invention will be more readily comprehended from the following detailed description when read in conjunction with the appended drawings, in which:

FIG. 1 illustrates a conventional commerce system;

FIG. 2 is a block diagram of a global integrated payment system constructed in accordance with an embodiment of the present invention;

FIG. 3 is a block diagram illustrating payment types and merchants' commerce applications used with a global integrated payment system constructed in accordance with an embodiment of the present invention;

FIG. 4 is a block diagram illustrating a system components architecture for a global integrated payment system constructed in accordance with an embodiment of the present invention;

FIG. 5 is a block diagram illustrating a system processing architecture for a global integrated payment system constructed in accordance with an embodiment of the present invention;

FIG. 6 is a block diagram illustrating exemplary components for implementing a global integrated payment system constructed in accordance with an embodiment of the present invention;

FIG. 7 is a block diagram for a director module constructed in accordance with an embodiment of the present invention;

FIG. 8 is a flow chart illustrating a sequence of operations for merchant activation using a global integrated payment system constructed in accordance with an embodiment of the present invention;

FIG. 9 illustrates a merchant home page configured in accordance with an embodiment of the present invention; and

FIGS. 10-16 illustrate exemplary web pages for a Merchant Integration Kit (MIK) in accordance with an embodiment of the present invention.

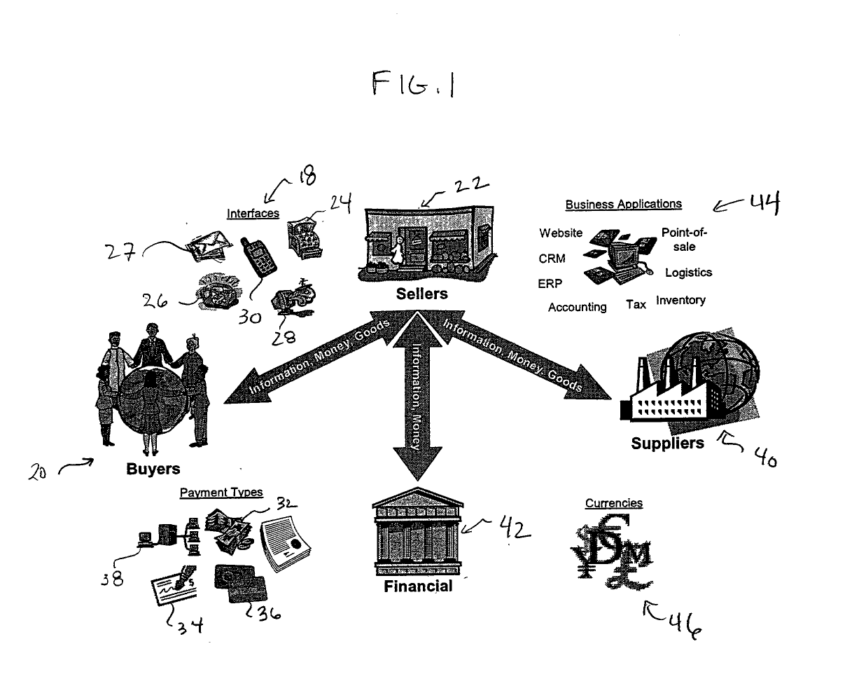

Throughout the drawing figures, like reference numerals will be understood to refer to like parts and components.

### DETAILED DESCRIPTION OF THE PREFERRED EMBODIMENTS

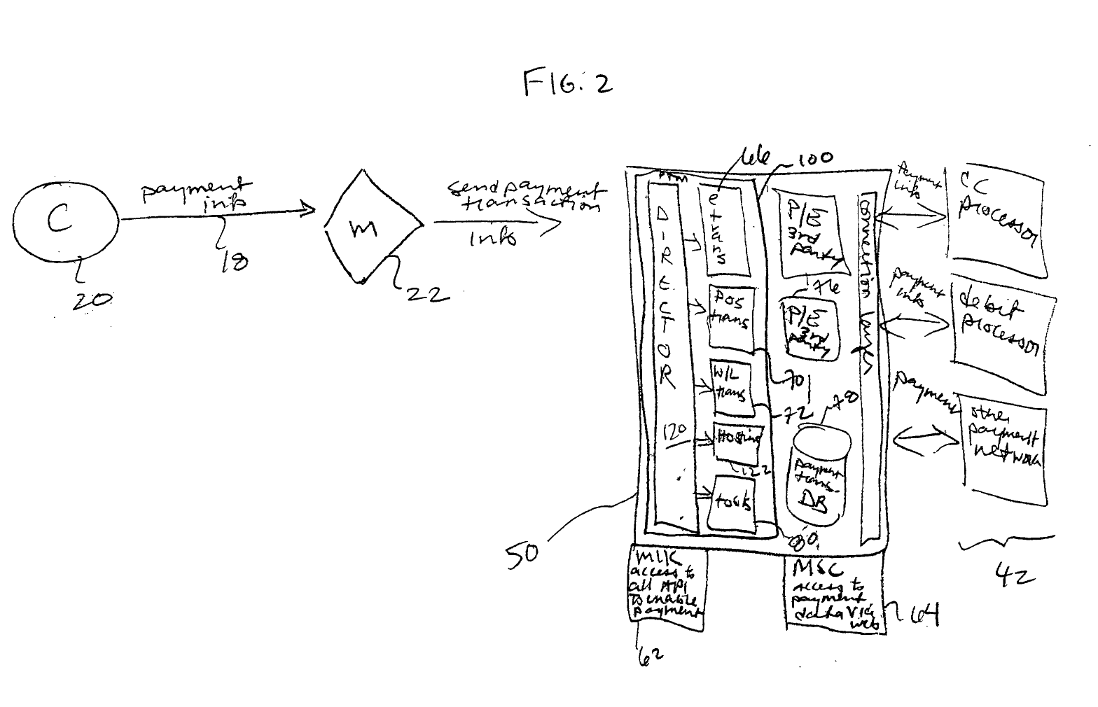

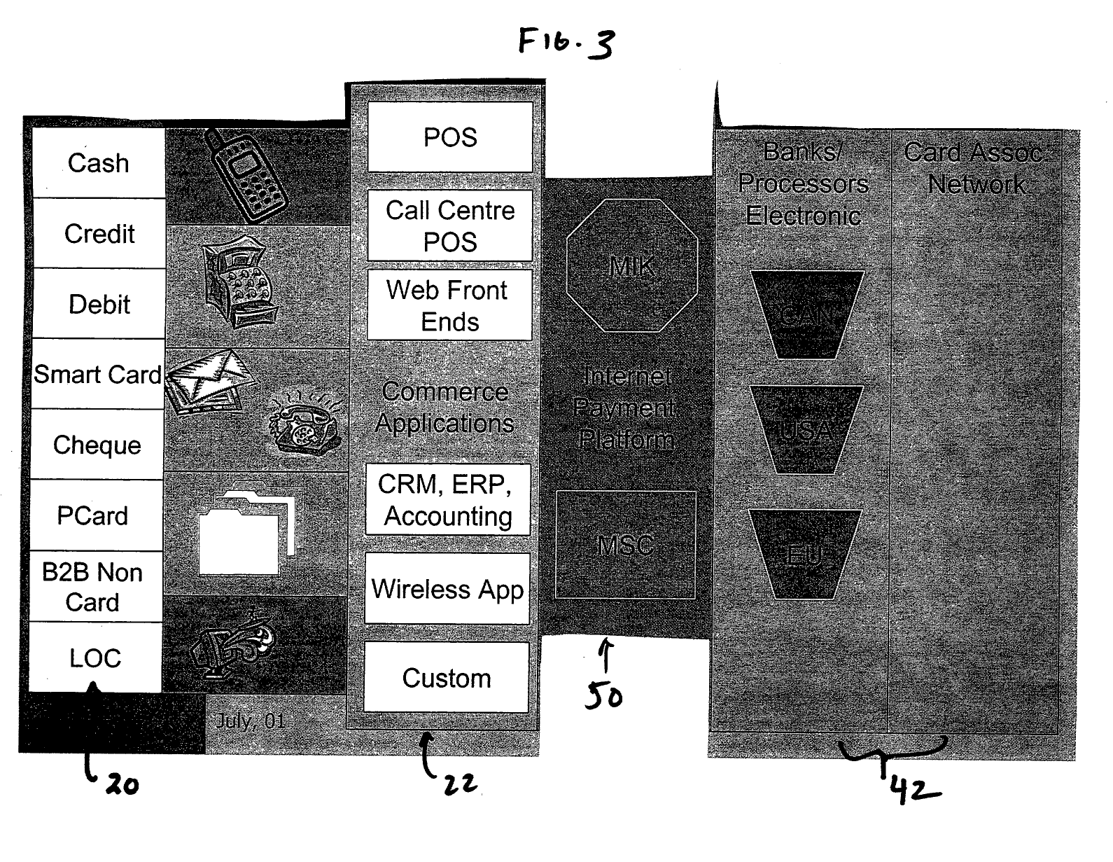

FIG. 2 illustrates a customer 20 undergoing a payment transaction with a merchant 22. The payment channel 18 between the customer and merchant can be, but is not limited to, communication via the Internet, telephone, a wireless communication device and corresponding wireless link, a point-of-sale transaction, interactive TV, and so on, as illustrated in FIG. 3. In accordance with the present invention, a global integrated payment system 50 provides the merchant 22 with one integrated payment platform to send all of its payment transactions. The system 50, in turn, manages the different protocols and channels needed to communicate with the various financial institutions 42 and service providers and thereby shields the merchant 22 from the complexities of communicating payment transactions to FIs.

With continued reference to FIGS. 2 and 3, the channel between the merchant 22 and the system 50 can be implemented via an application programming interface (API) at the merchant such as a payment plug for real-time transaction processing with the system 50. In accordance with another embodiment, the merchant can employ a payment cartridge that includes a payment plug at its core, as well as infrastructure to interface with different commerce applications such as Siebel Systems or a shopping cart or a point-of-sale (e.g., Micros, which is used in the food and beverage industry). The merchant can also employ a hosted solution. As illustrated in FIG. 3, the system 50 supports many commerce applications for communication with merchants such as, but not limited to, POS, call center POS, web front-ends, CRM, ERP and accounting applications, wireless applications and so on. The system 50, in turn, preferably uses different commerce applications to communicate via its back-end with the FIs 42 such as the payment engines of VeriFone/Hewlett-Packard, Clear Commerce or IBM, for example.

The system 50 is implemented with an architecture which allows the system 50 to process any type of electronic transaction in order to process the information and log the information and allow aggregation of all payment channels and all payment information in accordance with the present invention. Further, the payment information is then made accessible to decision-makers of any merchant 22 or FI 42 in real-time.

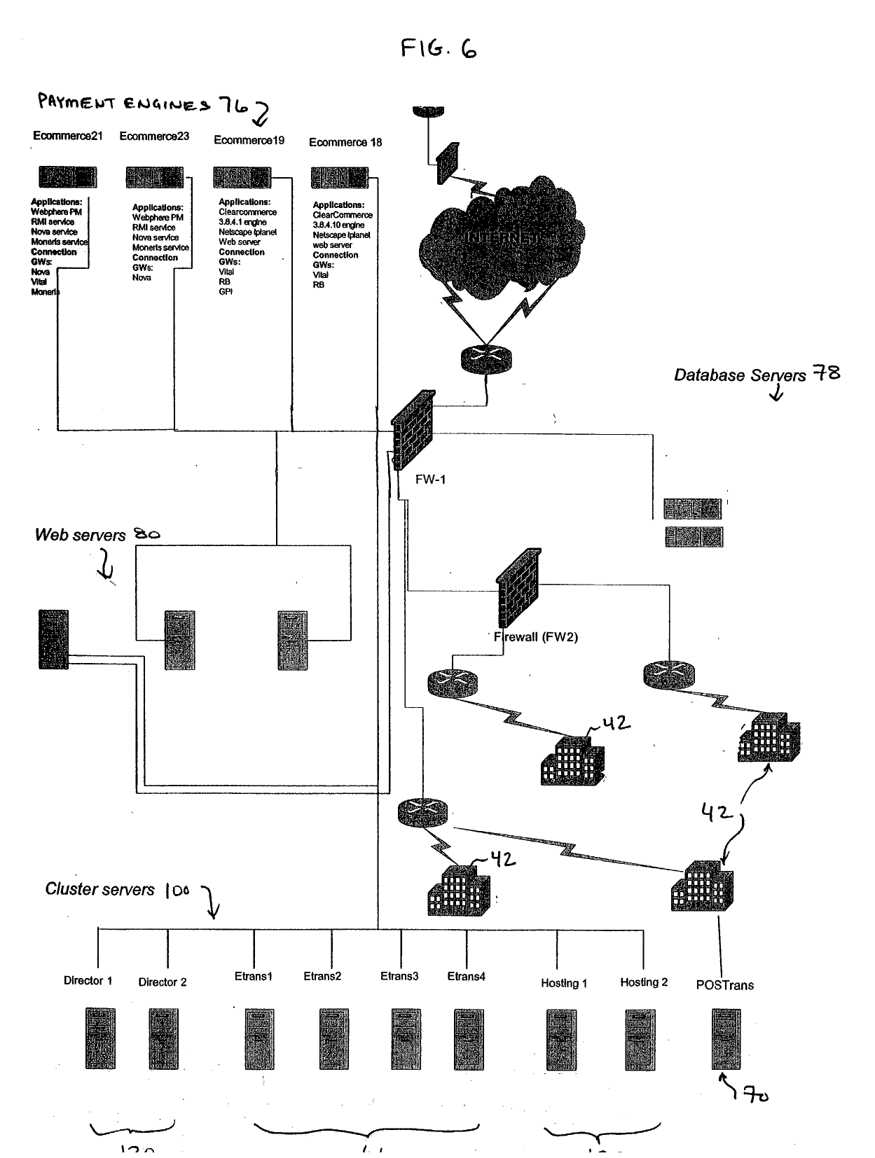

In contrast to existing financial payment processing systems and a current understanding within the payment processing industry, the system 50 does not equate the Internet with e-commerce, but rather sees the Internet an important backbone. Existing e-commerce platforms are vertical and tend to provide products that serve only one function such as Internet c-commerce or face-to-face product transaction commerce, but not both. VeriFone and IBM offer these products, for example. By contrast, the system 50 provides an aggregation of channels to the FI(s) 42 through one platform to simplify merchants' handling of transaction data with the various financial institutions 42. For example, the system can aggregate the interfaces of VeriFone terminals and IBM platform among other technologies. In addition, the system 50 gives merchants 22 one interface with the system to send all payment transactions. The system 50, in turn, employs leased lines, the Internet, wireless links and other information paths needed to communicate with the different FIs 42, and works with the components of the various service providers needed for such communications, as illustrated in FIG. 6.

In accordance with the present invention, a global integrated payment system 50 is provided to accommodate all sizes of merchants 22, that is, from small merchants to large enterprises, to facilitate the establishment, operation and management of their respective payment systems, including their transactions with their customers 20 and their financial institutions 42. The global integrated payment system 50 of the present invention also assists financial organizations 42 with implementing core payment technologies to process and manage payment transaction data from sellers or merchants 22, as well as provides activity, sales and marketing support to enable FIs 42 to offer payment services to sellers or merchants 22.

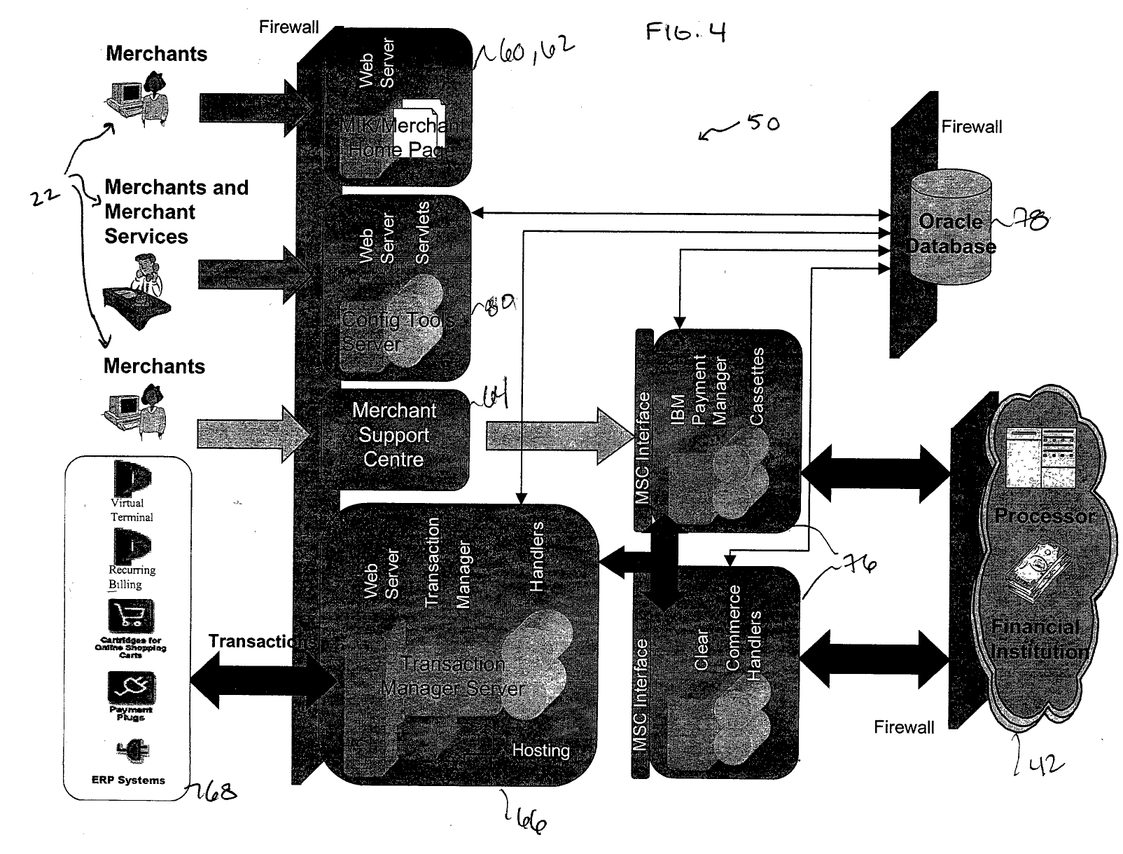

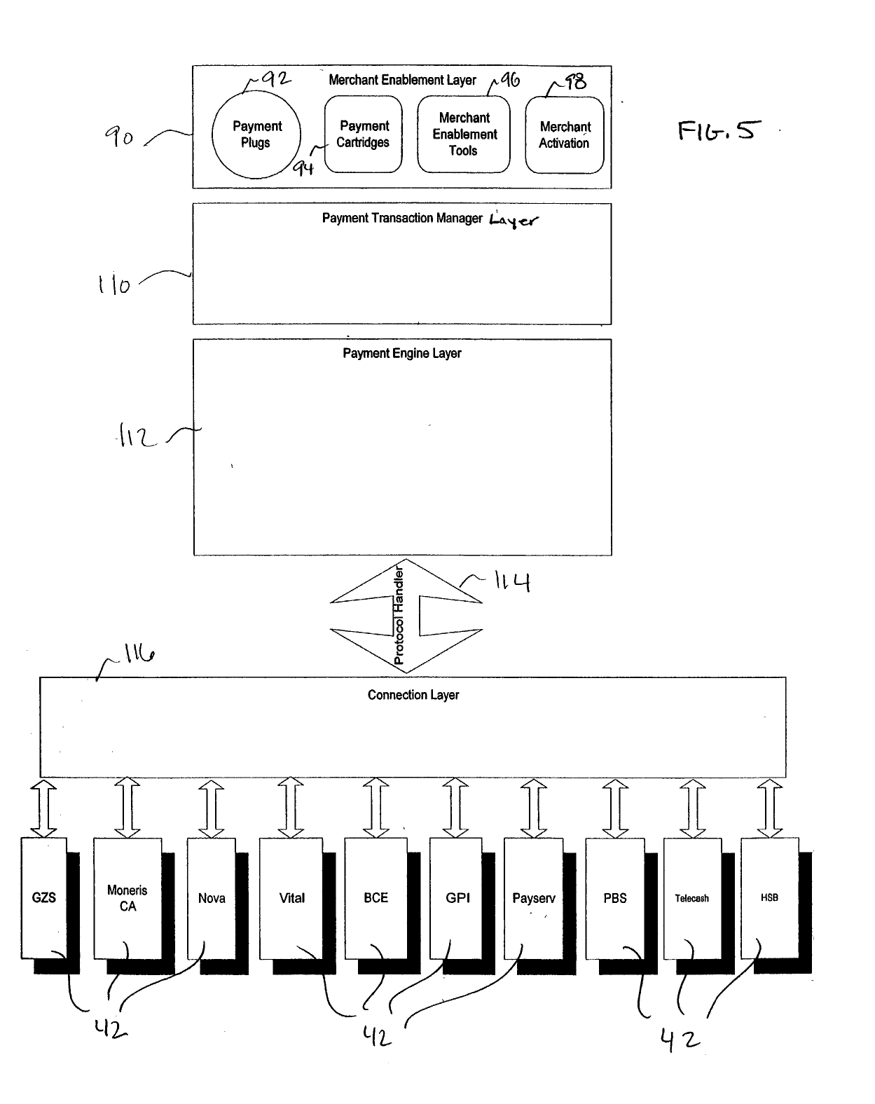

The system 50 will now be described in further detail in connection with FIGS. 2, 4, 5 and 6. FIGS. 2 and 4 each provide a system components architecture overview. FIG. 5 provides a system processing architecture overview. FIG. 6 illustrates exemplary components for implementing the system 50.

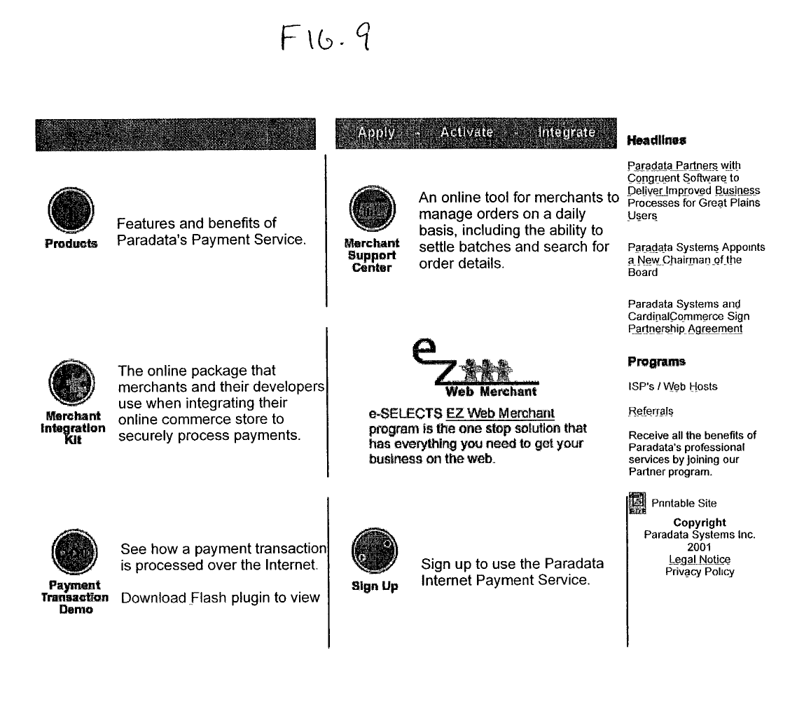

With reference to FIG. 4, merchants 22 have several options for interfacing with the system 50. For example, merchants can access a merchant home page 60, which is described in more detail below in connection with FIG. 9, to select from a number of merchant products if their online stores are currently configured but they need an electronic payment solution. Different merchant payment solutions are described below such as PayGateway Net™ to accept electronic payments via their online store, or PayGateway POS™ to use the Internet to process transactions in lieu of a dial-up solution. Merchants that do not have an online store or a secure online store can also select the Merchant Integration Kit™ (MIK) 62 from a merchant home page hosted by the system 50.

The system 50 preferably provides the merchant home page as a merchant relationship management and marketing tool. The merchant home page can be used before, during and after a merchant decides to use the tools offered by the system. The merchant home page assists merchants by outlining available products, providing product demonstrations online, as well as information, tools and support. The merchant home page can offer solutions as products such as an e-commerce solution, a virtual terminal solution, a wireless solution, a billing solution, and a POS solution, and provide information about obtaining a merchant account and accessing the MIK, and so on. The system 50 is unique in that it provides a complete tool kit for merchants, and its products are preferably introduced by navigating the merchant home page on the web.

The MIK 62 is the tool used by sellers 22 to enable their electronic commerce platform. The MIK is implemented by a payment transaction manager (PTM) 100 described in more detail below which includes many components such as pay plugs, cartridges, a call center, and so on, to aggregate the processing needed for supporting the various channels used for communication between a consumer 20 and a merchant 22. Through the MIK 62, merchants 22 can obtain tools such as plugs, Hosted pay pages, shopping cart cartridges, and the like, needed to contact the system 50. The MIK 62 provides merchants with an extensive portfolio of custom payment cartridges designed for the most popular commerce applications.

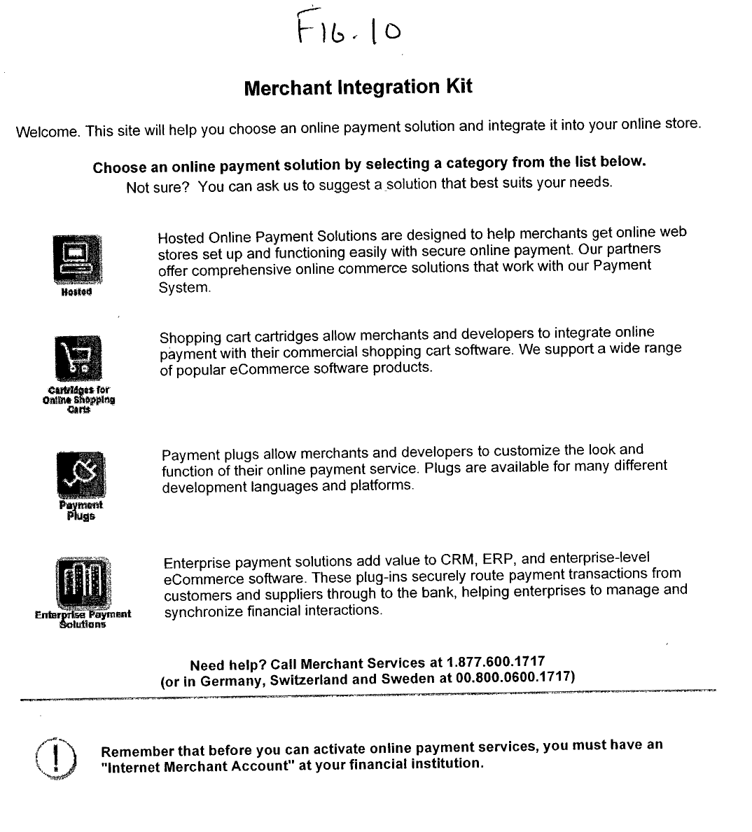

The MIK 62 provides the sellers 22 with the information they need to make choices about the solution that will best meet their needs, as illustrated by the exemplary screens described below in connection with FIGS. 10-16. The MIK 62 is user-friendly with simple point-and-click solutions, detailed instructions and resources needed by sellers and by the development community that serves them.

With continued reference to FIG. 4, the merchants 22 can also access a Merchant Support Center™ (MSC) 64 which is a tool that they can use on an ongoing basis once they have enabled themselves to conduct electronic transactions. The MSC is a database that stores the merchants' electronic transaction data and allows the merchants to manage their businesses. The seller can review transactions, issue voids and refunds, close batches and monitor electronic receipts. The MSC 64 provides merchants 22 with reporting and reconciliation tools to improve their operational efficiency while providing better data for decision-making.

The global integrated payment system 50 comprises a number of modules for supporting different payment transaction technologies. By way of an example, the system 50 comprises an e-commerce transaction module 66 referred to as ETrans™ shown in FIG. 4 for processing e-commerce transactions from merchant e-commerce applications 68 such as payment plugs, cartridges for online shopping carts, ERP systems, recurring billing systems and virtual terminals. As shown in FIG. 2, the system 50 can also have a POS module 70 (POSTrans™) for processing transaction data received via the Internet from a merchant's POS, a wireless module 72 for processing wireless payment transactions, among others.

In accordance with the present invention, the system 50 offers merchants 62 a selection of merchant-facing products indicated generally at 68 in FIG. 4 that will now be described. The system web servers that support these merchant products are indicated at 80 in FIG. 6. As stated above, merchants 22 can access these products via the MIK 62 or the merchant home page 60. For example, PayGateway Net™ is a secure, real-time credit card processing service for a merchant's web site. PayGateway Net™ allows merchants to set up their web sites to authorize, process and manage credit card transactions in real-time and thereby accept electronic payments from an online storefront. The PayGateway Net™ tool contains solutions for all types of merchants, that is, from large to small merchants and from experienced to novice merchants with regard to e-commerce applications. The solutions provide state-of-the-art security of financial information, are easy to use, and are customized to work seamlessly with a majority of the currently popular e-business applications in use. The system 50 also offers a 3D Secure version of the PayGateway product. This solution helps merchants accept major credit cards (e.g., Visa, MasterCard, American Express, JCB, Discover Card and Diners Club/Enrout) and therefore comply, for example, with both Visa's Verified by Visa (VbV) solution and MasterCard's Secure Payment Application (SPA). The system 50 can therefore ensure a merchant that their customers can shop online, hassle free, 24 hours a day, 7 days a week. The payment solution is designed to grow with a merchant's business and technology needs. Whether a merchant handles fewer than fifty transactions a month, or thousands each day, the PayGateway Net™ solution is a flexible and scalable solution to increase a merchant's competitive advantage.

PayGateway Net™ is easy to set up and can be quickly integrated into a merchant's existing web site. The MIK provides step-by-step online documentation, as well as a range of downloadable payment solutions that work with the most common third party e-commerce software and all major platforms and programming languages. The MSC allows these merchants, among others, to easily view, capture, void, credit and settle individual orders and otherwise securely manage transaction data online.

A PayGateway Virtual Terminal™ solution is provided for merchants that accept orders over the telephone, or at a call center, or manually authorize and process credit card transactions in real-time. The PayGateway Virtual Terminal™ is an easy to use solution for both large and small businesses that manually enter credit card transactions for mail or telephone order sales. PayGateway Virtual Terminal™ provides a secure interface that allows merchants to authorize, process and manage credit card transactions from any computer that has a web browser and Internet connection. These solutions can meet the electronic payment needs of call centers, trade shows and traveling sales people who do not want to lease a credit card terminal or purchase a separate telephone line. The solution can be integrated into the customer's CRM system and helps to reduce errors, to improve the customers' overall experience with the call center, to reduce the total cost of collecting funds, to securely and reliably process customers credit cards in real-time, to improve back office reporting and reconciliation functions, to increase the speed for agents to collect and process payment, to set up individual logins for each of the agents, and to perform sales, authorizations and credits.

For a merchant 22 to access its own personal virtual terminal, its call center agent simply clicks on a web link and enters its user name and password. The agent can then enter the credit card information into a screen on his computer. Within a few seconds of hitting the “Perform Transaction” button, the agent receives an approval or decline response back. If the card is declined, the agent can ask for another card and complete a sale that might otherwise have been lost while the customer is still on the telephone. The solution obviates the need for batch processing, walking to a physical POS terminal and keying in credit card numbers, paying for additional telephone lines, waiting to begin order fulfillment, and call backs to customers about declined cards or data entry errors.

PayGateway Biller™ allows merchants to automatically charge customers' credit cards on a recurring basis and/or present bills electronically. These solutions are designed meet the needs of merchants 22 that want to present bills electronically and/or collect recurring payments. Biller™ provides solutions for all sizes of merchants and for varying complexities of bill or invoice presentment. A B2B solution is provided that allows for line item disputes. A small biller solution offers the ability to outsource the paper invoice distribution, as well as the electronic presentment. For recurring payment only, the system 50 offers two products, that is, a subscription product for billers that bill their customers a constant dollar amount on a regular periodic basis. Also, a bulk payment tool is provided for billers that bill varying dollar amounts. Improving business efficiency, improving the customer experience and improving the collection of funds are all key benefits of these solutions. The recurring billing solution allows for CVV2 input, and allows billers to choose start date, end date, frequency and can include Level 2 tax data.

PayGateway Recurring Biller™ allows merchants to automatically charge their customers pre-authorized credit cards on a monthly recurring basis. Through the user-friendly web interface of the PayGateway Recurring Biller™, merchants 22 can easily add, modify, pause or delete customer accounts to be charged on a certain day each month. The system 50 then automatically processes credit card transactions on their scheduled dates saving merchants valuable time. PayGateway Recurring Biller™ allows merchants to streamline their billing processes by allowing them to automatically charge credit cards on a monthly basis, update and maintain billing information through an easy to use web interface, have the option to automatically e-mail payment confirmation to their customers, receive daily e-mail summaries of transaction results, eliminate the need to store their customers' credit card information since the system 50 stores the information, and set up their own user preferences based on their business needs.

PayGateway POS™ solutions are provided for retail merchants 22 with face-to-face customer interaction. These solutions leverage the power of the Internet to lower costs and improve transaction-processing speed. Merchants that may have relied on slow dial-up solutions can now process transactions quickly and efficiently using the PayGateway POS™ solution.

Increasingly, merchants want to accept payments through devices such as personal digital assistants, or mobile telephones. The system 50 provides a portfolio of wireless payment solutions (i.e., PayGateway Wireless™) designed for mobile payment applications that provide sellers 22 with the flexibility to accept payments anywhere.

Many merchants 22 offer the customer 20 the option to choose between multiple interfaces for completing a transaction. A merchant that has a website, multiple retail storefronts, and a call center likely has three or more different electronic payment management systems. A PayGateway Integrated Platform™ is provided that allows multi-channel/multi-location merchants, as well as several merchants with respective types of commerce applications, to simplify and enhance their electronic payments infrastructure to lower costs, improve efficiencies and improve the customer experience using a single integrated platform with proven communication paths to FIs 42 and tools to integrate different solutions.

Other tools available to merchants to move all of their payment needs onto one common platform in accordance with the present invention are tools to handle ACH/EFT payments, electronic check solutions, stored value solutions, loyalty solutions, enhanced reconciliation and reporting products, and multi-currency processing solutions.

As stated above, merchants 22 can connect to the system 50 via a plug or shopping cart, as indicated at 68 in FIG. 4. A payment plug is an Application Programming Interface (API) in a computer language such as Java or Perl that allows online payment transactions to be processed. Payment plugs allow merchants and developers to customize the look and function of their online payment service. Plugs for many different development languages and platforms are available via the system 50. Merchants can elect to use one of the payment plugs if they have developed their own shopping carts, or are connecting to an interface such as an IVR (Integrated Voice Response) system or wireless telephone. If a merchant was not yet purchased Shopping Cart software for its store, the merchant can evaluate shopping cart packages for which the system 50 has cartridges. The system 50 provides an extensive portfolio of custom payment cartridges designed for the most popular commerce applications. These products are among the best and most popular in the industry, and easy to integrate as an online payment solution. The system 50 is advantageous because it is configured to allow merchants 22 to browse through the system's suite of PayGateway products and choose the best product for their business environments.

With continued reference to FIGS. 2 and 4, the payment transaction modules (e.g., ETrans 66, POSTrans 70 and Wireless Trans 72) each preferably have a transaction manager server and handlers for forwarding payment transactions received from merchants 22 to the necessary payment engines 76, storing transaction data in a system database 78 (e.g., for use by merchants via the MSC and by FIs), and forwarding to the necessary FI 42. As shown in FIGS. 2, 4 and 6, the system preferably employs a plurality of payment engines 76.

As shown in FIG. 5, the system processing architecture generally comprises a merchant enablement layer 90, a payment transaction manager layer 110, a payment engine layer 112, a protocol handler 114 and a connection layer 116 for communicating with a number of exemplary FIs 42 and their respective commerce applications such as Moneris, GPI and Vital. The architecture in FIG. 5 is advantageous because it simplifies online payment system set-up and use for merchants 22 by shielding them from the technical requirements that must be met to support the merchant's communications with one or more of their FIs 42. The architecture also shields processor/acquirers 42 and other FIs from the time, expense and complexity of acquiring sellers 22 of different sizes using different communication and payment technologies.

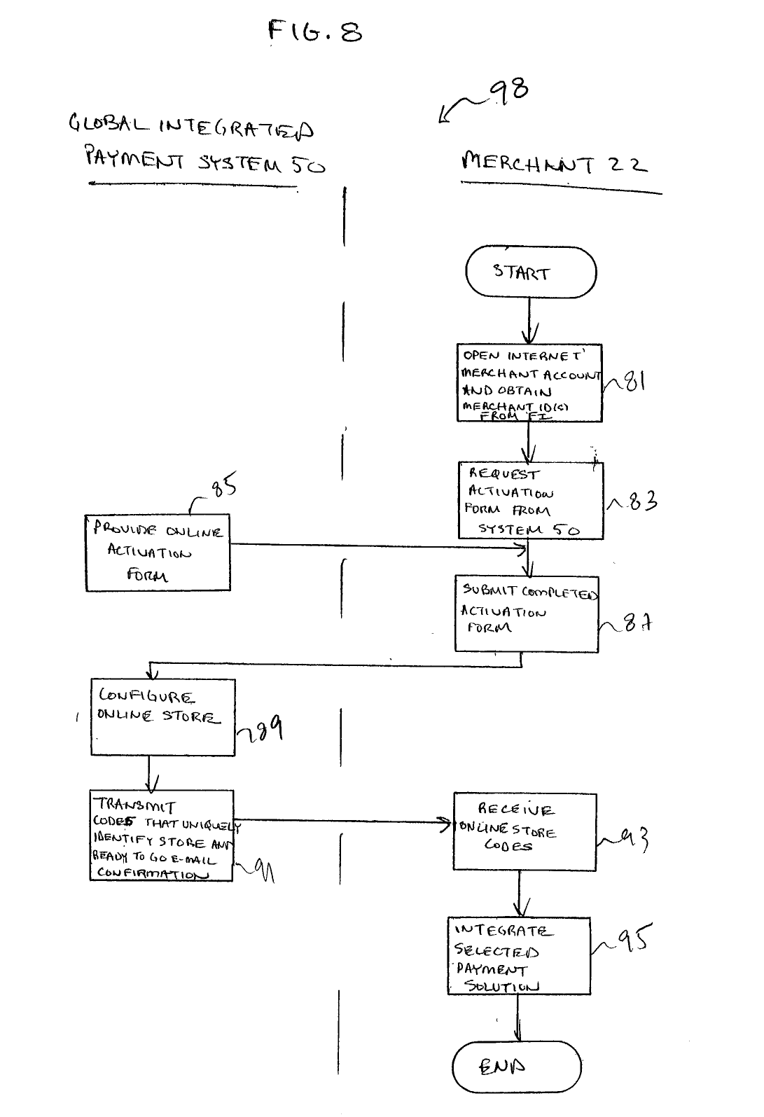

The merchant enablement layer 90 provides and supports merchant modules described above for accessing the system 50 such as plugs 92 and cartridges 94. The layer 90 also supports merchant enablement tools 96 such as the MIK 62 for access to merchant-facing products (e.g., PayGateway Net™), plugs, cartridges for shopping carts, a hosted pay page, and so on. Merchant enablement tools 96 also includes the MSC 64 for access to the Virtual Terminal and Biller components described above. Merchant activation 98 is also included, that is, the process whereby a merchant account is created in the system 50. Activation is described below in connection with FIG. 8.

The payment transaction manager layer operates via the different payment transaction modules 66, 70 and 72, among others, to securely route transactions from the merchant 22 to the back-end of the system 50, that is, the paths between the payment engines 76 and the corresponding FI(s) 42. Regardless of the processor 42 a merchant uses, the system 50 establishes a robust connection to the processor or FI 42 via the payment transaction manager layer 110, the payment engine layer 112, the protocol handler 114 and the connection layer 116. The back-end, that is, the interface between the system 50 and the various FIs or financial organizations (FOs) is an important component of the system 50. Although, the payment engines 76 used to connect to FIs are not new, the manner by which the system 50 uses the Internet to accept transactions from consumers 20 and merchants 22 and aggregates them on behalf of the merchant using one interface or payment platform is an important aspect of the present invention.

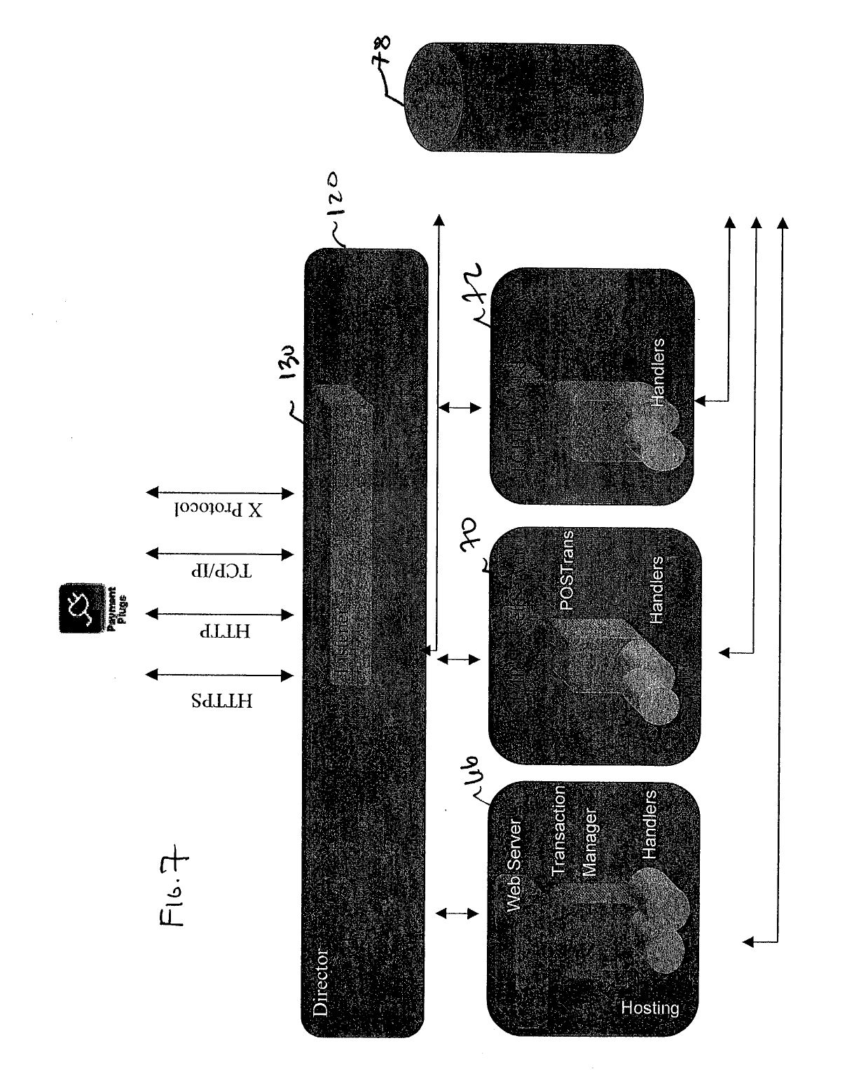

As shown in FIG. 2, the system 50 comprises a director server application 120 to manage the aggregation of different types of transactions. The director 120 determines the type of transaction from the transaction data received from the merchant 22. The director 120 then determines which payment engine 76 to employ for that merchant 22, the transaction type and which processor or FI 42 to use. The director 120 is also provided with information to determine where to log the transaction in the database 78. The data flow is illustrated in FIG. 7.

The director 120 contains listener modules 130 that examine incoming transactions to determine the various protocols used such as the HTTPS Credit protocol, the HTTP Credit protocol, the TCP/IP POS protocol, the HTTPS SOAP protocol, and the Transaction XML protocol. Both the director and the corresponding XTrans application (e.g., ETrans 66, POSTrans 70, or WirelessTrans 72) write to a single format database schema in the database 78 that contains a record of all transaction history and is updated as different layers are accessed. The director 120 allows different nodes to be added/removed from the access list, as well as sets the rules by which they are accessed (e.g., frequency, concurrency, timeouts, and so on).

The director 120 is “smart”. The purpose of the director 120 is to accept any payment transaction, from any device, using any protocol via the system 50's payment plugs. The director 120 is referred to as a “smart” device because it reviews each transaction accepted and, based on transaction type, directs the transaction to the corresponding component for processing on the appropriate network. The system 50's payment plugs are unique because a merchant only needs one plug and therefore one integration to process transactions of any type. The database 78 created for all transactions being sent through the PTM 100 is important because this database aggregates all data from a merchant's site, that is, all types of transactions from all sources. This allows a merchant to access up-to-the-minute information and increase their decision-making capabilities.

The global integrated payment system 50 of the present invention provides an electronic payment infrastructure that integrates with the technological infrastructure in place within an organization 42 and provides a robust electronic payments platform that can be easily adopted by their commercial clients. The system 50's core technology was developed with flexibility to integrate into any FI's back-end payment system. As shown in FIG. 2, a Payment Transaction Manager (PTM) 100 securely routes transactions from the merchant 22 to their “back end” systems. Regardless of the processor 42 used, the system 50 can establish a robust connection. Once an authorization of that transaction is complete, the PTM 100 forwards the appropriate response to the seller 22. The system 50's standard for completing an end-to-end transaction is preferably less than four seconds. The system is preferably operational 24 hours a day and 7 days a week to meet market demands.

With reference to FIG. 2 and the illustrative implementation depicted in FIG. 6, the system 50 preferably employs at least the following:

The transaction engines 76 include, but are not limited to, the following engines:

1) IBM Payment Manager 2.2

Vital Cassette: Provided by IBM. Socket connection via a leased line.

Nova Cassette: Developed for the system 50. The Nova cassette communicates via

RMI to a service that establishes an SSL connection with the gateway at Nova.

Moneris Base24 Cassette: Developed for the system 50. The Moneris Base24 cassette communicates via a socket over a leased line.

BCE/Assurepay Cassette: Developed for the system 50. The Moneris Base24 cassette communicates via RMI to a service that establishes a socket with the Base24 Host over a leased line.

2) ClearCommerce 3.8.4.1

Moneris vGate: Provided by ClearCommerce. Connects to a vGate via SSL/HTTPS.

GPI: Provided by ClearCommerce. Connects to the GPI gateway via a socket connection over a leased line.

3) ClearCommerce 3.8.4.10

Vital: Provided by ClearCommerce. Connects to the GPI gateway via an https connection.

4) ClearCommerce 5.0

Vital: Provided by ClearCommerce. Connects to the Vital gateway via a socket connection over a leased line.

FDMS: Provided by ClearCommerce. Connects to the FDMS gateway via a socket connection over a leased line.

Paymentech; Provided by ClearCommerce. Connects to PIT gateway via a socket connection over a leased line.

The tools 80 include, but are not limited to, internal tools such as:

1) MailNurse—

All system components write to the MailNurse database to facilitate both internal and external e-mails;

2) Template Editor—

A servlet based tool that allows Merchant Services to configure the Hosting look and feel for Hosted merchants;

3) Hosting Config—

A servlet based tool that allows Merchant Services to configure the Hosting account for Hosted merchants;

4) Token Generator—

A servlet based tool that generates unique tokens for the Payment Transaction Manager interface for a specified store;

5) ETrans Config—

A servlet based tool that allows ETrans accounts to be created, configured, and deleted for a corresponding account on any of the transaction engines in use;

6) Reseller Config—

A servlet-based configuration tool that allows resellers to be configured on the system reseller servlet system; and

7) Customer Management System (CMS)—

A servlet-based system that allows merchant account information to be entered and updated for billing as well as customer tracking purposes.

The tools 80 also include, but are not limited to, external tools such as:

1) Email Forms—

Customer requests and initial enrollment e-mails are all generated by this servlet.

2) Reseller Servlet—

Servlet allows all resellers to login uniquely and register/activate corresponding merchants on the activation system.

3) Token Dispenser—

A servlet that allows a merchant to logon and authenticate themselves in order to retrieve a token for the Payment Transaction Manager or the Hosting system.

4) Hosting Wizard—

Allows the merchant to configure a subset of their Hosting parameters.

5) Activation Servlet—

Allows the merchant to submit all of their merchant account information in order for their account to be created and configured.

6) Download Servlet—

The servlet interface that records client information that is required when an integration solution is downloaded from the MIK.

The above-described Virtual Terminal and Recurring Billing Products are preferably implemented via the web servers 80 in FIG. 6 as follows:

1) The Virtual Terminal Product is a webserver based tool that is written in Perl. Authentication provided to directory access is configured within the webserver via the .htaccess file. Every Virtual Terminal configured corresponds to a particular merchant account. This tool allows all transaction fields to be submitted as part of a transaction. This includes billing, shipping and transaction information. Charge types: AUTH, SALE, CAPTURE, CREDIT, VOID.

2) The Recurring Billing Product is a servlet-based system that uses Enterprise Java Beans using a JBoss application server that supports J2EE architecture. Authentication is dome per merchant account. The merchant account information as configured in the Payment Transaction Manager system 100. Customers, as well as recurrences, are entities within the system 50 where charges can be set to occur with a certain period with a configured start and end date.

As stated above, the system 50 provides hosting, which is a servlet-based system 122 that host's payment request pages, as well as receipt pages, for merchants 22 who do not have the technical ability to integrate a payment API. The system 50 has a relatively complex schema that contains configuration information about the merchant account, as well as the URL to be used to post transaction response information back to, and confirmation e-mails for, the merchant.

The Payment Transaction Manager 100 preferably employs, but is not limited to, the following handlers:

ClearCommerce 3.8.4.1 Handler

ClearCommerce 3.8.4.10 Handler

ClearCommerce 5.0 Handler

IBM Nova Handler

IBM Base24 Handler

IBM BCE/Assurepay Handler

IBM Vital Handler

Moneris Alamo Handler

The Payment Transaction Manager 100 is preferably a servlet-based system that uses the account token paradigm to identify the merchant 22 as part of a submitted transaction. Based on the merchant configuration, a class that represents that appropriate handler is instantiated to route the transaction to the proper payment engine 76, cassette, and finally the proper gateway 42. This system can be configured to accept various types of transactions including credit card, SET, and Verified By Visa transactions. Its architecture is such that new types of transactions can be handled by adding new components at both the interface and handler layers. The Payment Transaction Manager Boxes are preferably clustered Linux boxes running an Apache/Tomcat configuration for the servlet engine. The clustering infrastructure uses a director node 120 to redirect transaction to the four ETrans boxes 66 in a round-robin fashion.

The PTM 100 can also direct POS transactions to the POSTrans module 70 which has the Moneris POS Retail specification handler, Ingenico/Moneris POS interface. POSTrans is a Java based client/server application that accepts connections from the Tender Retail API that supports POS transactions. POSTrans re-directs the incoming packets to the Moneris POS Retail Host while recording the transaction information as it passes through as a request as well as a response. The system supports any processor that the Tender Retail API supports, as well as any pin pad.

The system 50 of the present invention employs a robust payment manager 100 that handles high transaction volumes using proven commerce applications and channels. As stated previously, an important piece of the system technology is the back-end, that is, the interface between the system 50 and various FIs 42. The payment engines 76 used to connect to FIs 42 are not new; however, the manner by which the PTM 100 uses the Internet to accept transactions from consumers and merchants and aggregates them on behalf of the merchants using one interface or platform is an important advantage of the intention. The present invention presents a simple interface for the merchant because the system 50 is configured to examine the different transaction data from merchants and decide where to go. For example, the PTM 100 looks at the different types of data received from merchants and labels the different transaction data to know how to process it accordingly. More importantly, the simplified interface or platform for the merchant facilitates the system function of giving data back to the merchants via the MCS 64 to facilitate their decision-making processes. For example, a merchant can use a full import/export exchange of data, or receive transaction data by e-mail or log on to the back-end of the system's site to access the Merchant Support Center 64 and see the actions performed by the PTM 100 and follow-up on them. The present invention allows for the ease of information to be provided to one platform in one format and makes the data available to the merchant for use in the decision-making process.

Merchant activation 98 will now be described in connection with FIG. 8. Online payment processing provides merchants the ability to accept payments for goods and services in real-time over the Internet. Transactions are processed in a similar way to that of a physical POS terminal found at the cash register of a typical retail store. A merchant 22 enables a store for online payment processing in accordance with the present invention preferably by first applying for an “Internet Merchant Account” at a participating financial institution 42, if the merchant has not already done so (block 81).

After the merchant receives its merchant ID(s) from its Financial Institution(s), the merchant is ready to sign up with the global integrated payment system 50 of the present invention. The system 50 preferably provides merchants with a web-based activation form (block 83, 85 and 87) for obtaining the information necessary to configure the merchant's online store on the payment gateway (block 89). The system 50 then e-mails codes (block 91) to the merchant that uniquely identify the merchant's store so that the merchant can begin the process of integrating the payment solution it has chosen. When the online store has been configured, the system 50 sends the merchant a ReadyGo e-mail confirming that the merchant can begin integrating one of the payment solutions and outlining steps the merchant needs to follow. Once the merchant has received the ReadyGo e-mail (block 93), the merchant can integrate the payment solution (block 95) it has chosen using easy-to-follow documentation provided in the Merchant Integration Kit and thereby connect their website to the payment gateway of one or more FIs.

The system 50 preferably charges a fee for providing its integrated interface with respect to FIs, among other services. The activation form can be used to obtain the merchants agreement to sign up for the online payment service of the present invention and the associated fee. The merchant can then be billed for the service in 30 days or after it has gone live, that is, the store is posted on the web, whichever comes first.

The merchant can also place an online commerce shopping cart on its web site using one of the shopping cart cartridges available via the merchant enablement layer 90 (FIG. 5) of the present invention. The online payment processing service of the present invention is advantageous because it provides merchants with easy to implement, step-by-step integration procedures.

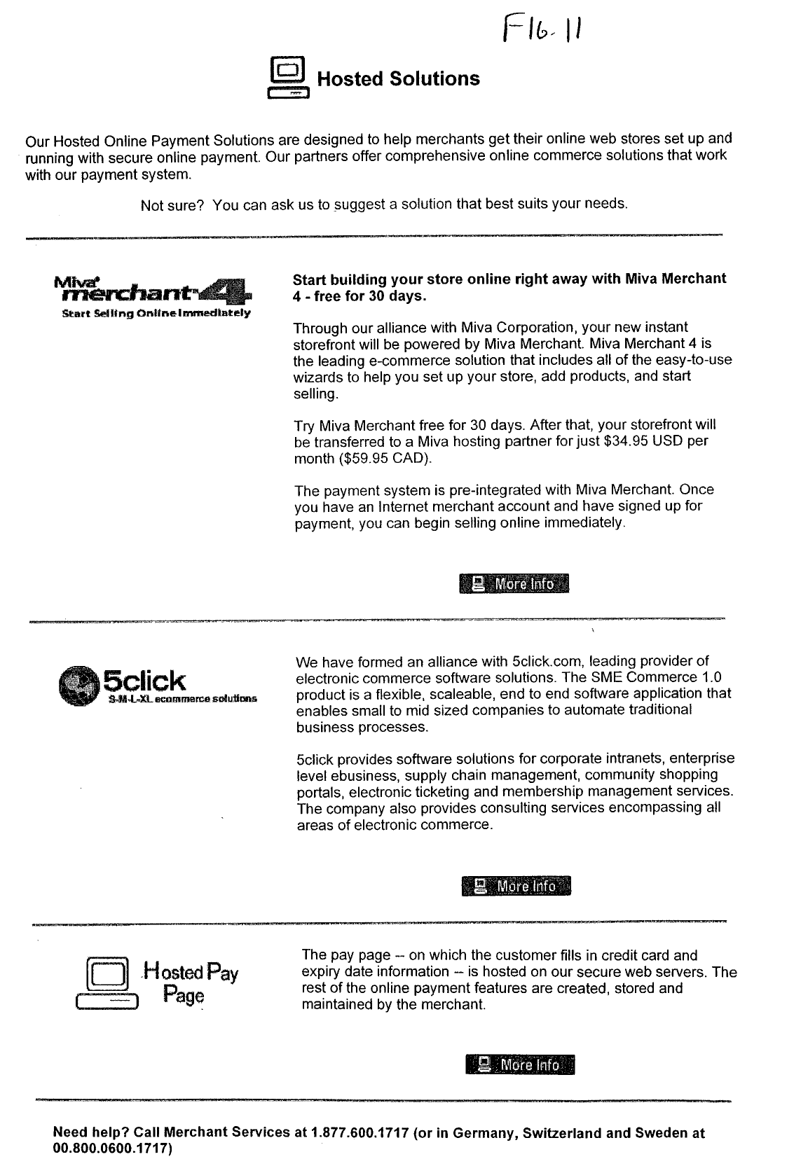

The exemplary Merchant Home Page depicted in FIG. 9 allows merchants to select “Products” to learn more about the PayGateway Suite, for example, or to select the MIK 62 or MSC 64. If MIK 62 is selected, icons and text outline solutions are provided to merchants in an exemplary MIK screen such as that depicted in FIG. 10 for navigation to other web pages (FIGS. 11-16) that provide information on the respective solutions.

With reference to FIG. 11, Hosted Online Payment Solutions are designed to help merchants get online web stores set up and functioning easily with secure online payment. Third party partners offer comprehensive online commerce solutions that work with the system 50. The MIK 62 can direct merchants to pre-approved “bundled” solution providers selected to meet the needs of smaller or less technically capable merchants. The MIK 62 can also host a pay page for merchants without a secure server.

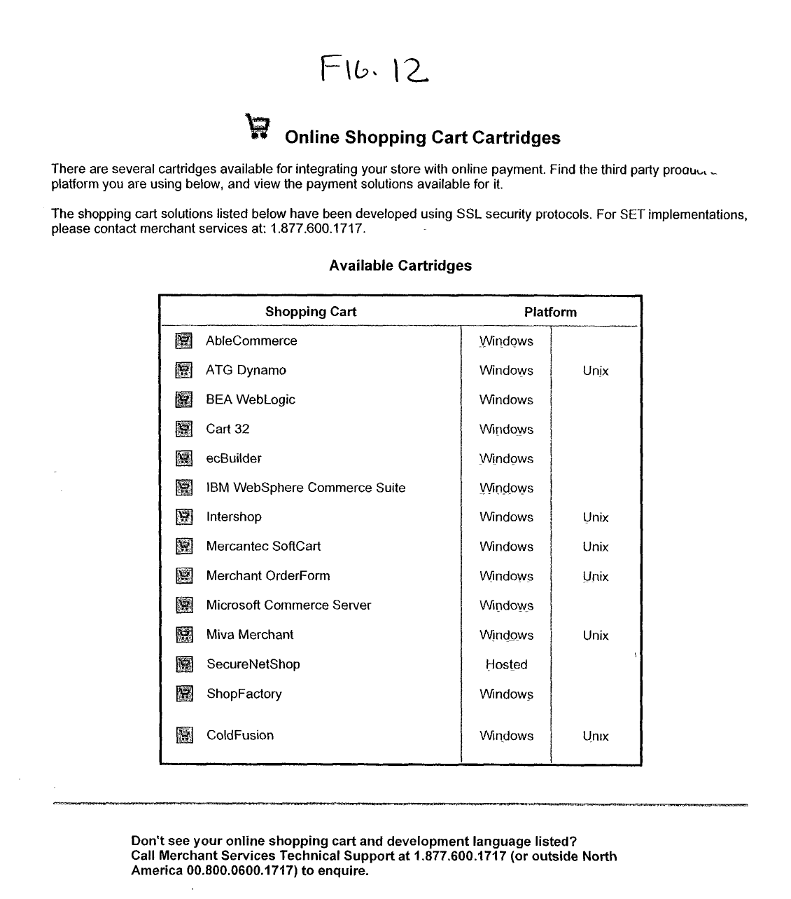

With reference to FIG. 12, shopping cart cartridges allow merchants and developers to integrate online payment with their commercial shopping cart software. The system 50 supports a range of popular e-commerce software products including the shopping cart solutions most often demanded by online merchants, shopping art solutions in Windows and Unix platforms, SSL solutions, SET solutions and 3D secure solutions.

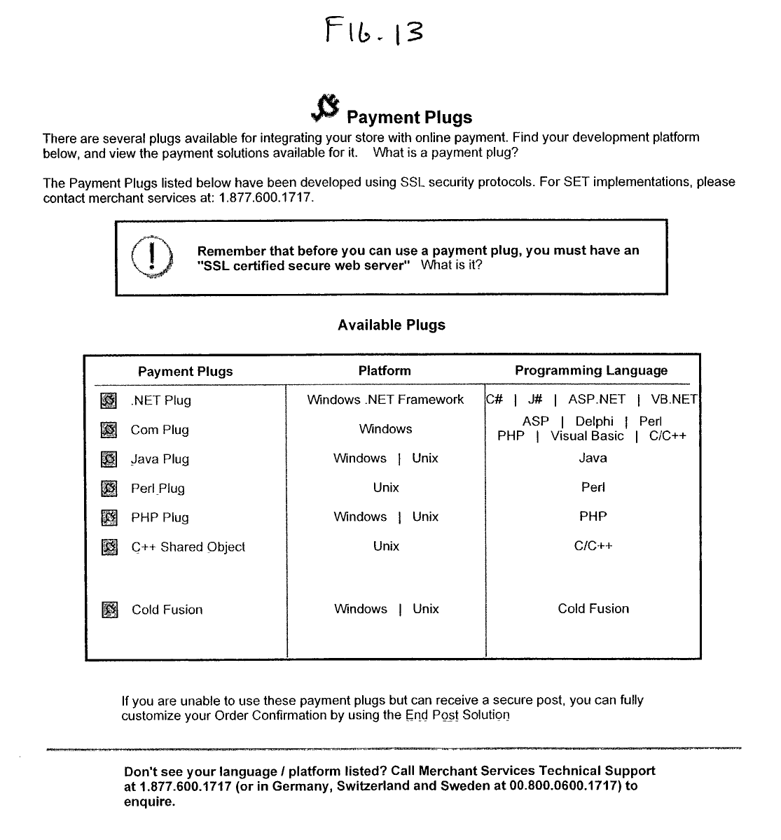

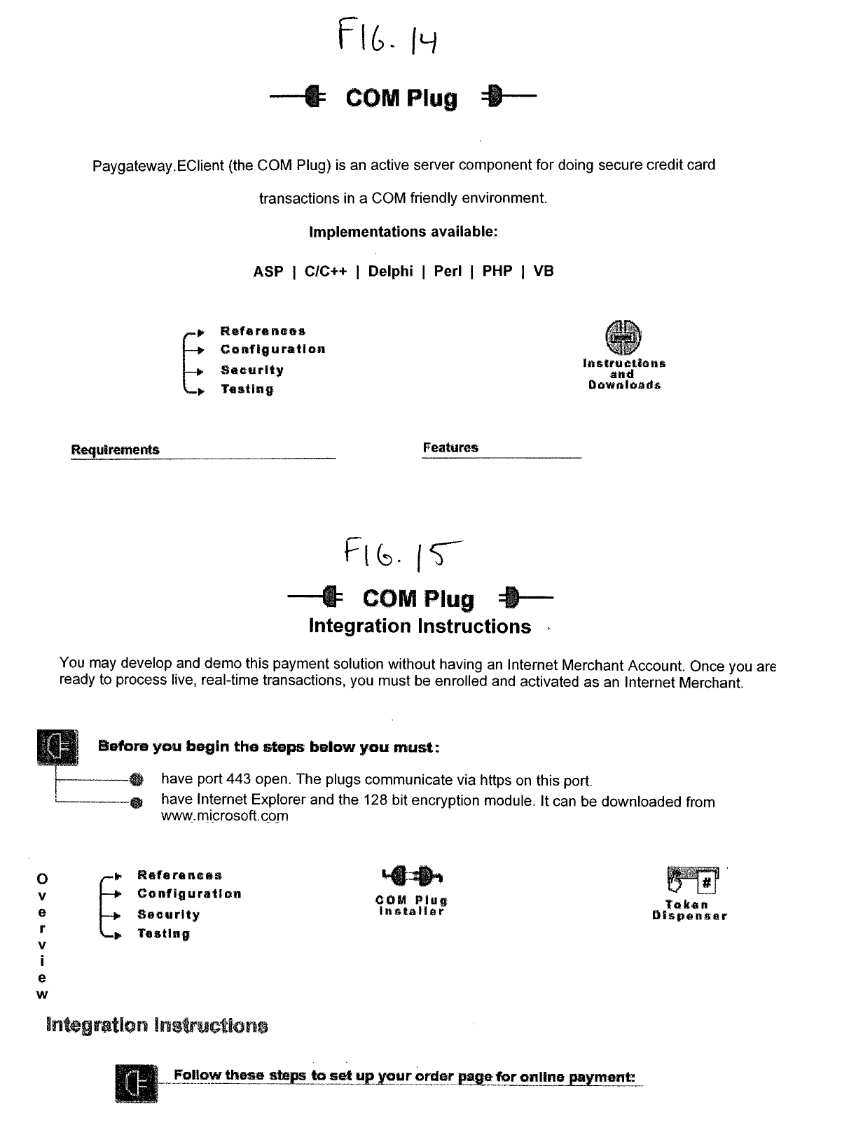

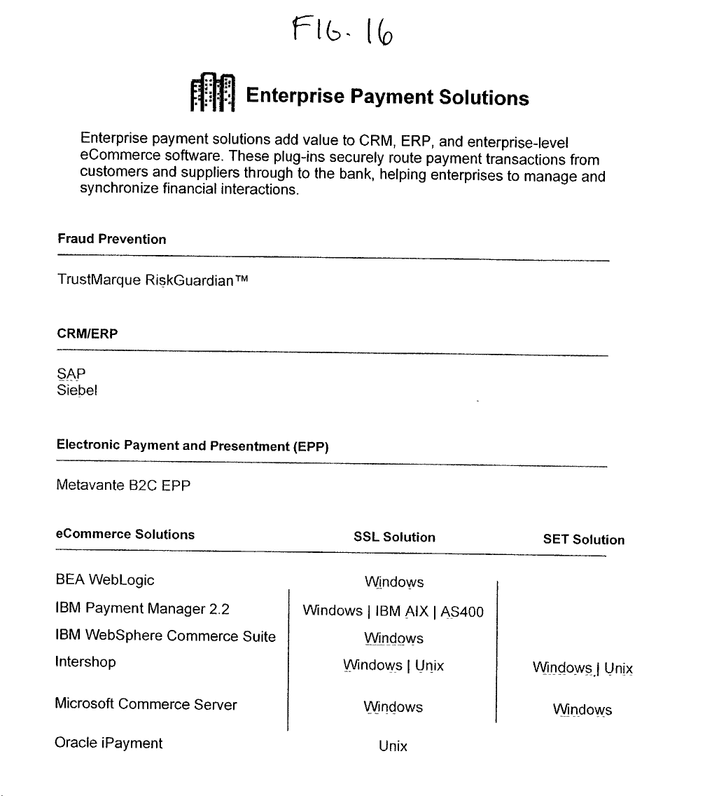

With reference to FIG. 13, payment plugs allow merchants and developers to customize the look and function of their online payment service and are most likely used for experienced developers and custom applications. Plugs are available for many different development languages and platforms. An exemplary plug is depicted in FIG. 14. Requirements and features of the plug such as those in Table 1 below are preferably made explicit to aid the developer in selecting the best e-commerce solution. With reference to FIG. 15, integration instructions are provided such as those in Table 2 below.

TABLE 1
Plug Requirements and Features

| Requirements | Features |
|---|---|
| Microsoft Internet Explorer 5.5 SP2 or 6.0 on | Offers maximum security |
| Microsoft Windows. Netscape Navigator 6.2.x | for all transactions. |
| on HP-UX, Sun Solaris, or Microsoft Windows | |
| Windows NT 4.0 SP4/2000 | You control the appear- |
| | ance and behavior of all |
| | HTML pages. |
| Internet Information Server 3.0, 4.0, or 5.0 and | You control the appear- |
| Active Server Pages, or Personal Web Server | ance of the e-mail Order |
| and Active Server Pages, or Visual Basic, C++, | Confirmation. |
| or any other development environment | |
| supporting COM components. The | |
| development environment must support | |
| accessing variables by reference. | |
| Ability to develop in your environment. | You control the trans- |
| | action data for record |
| | keeping. |
| An SSL certified secure web server. | The transaction flow is |
| | seamless - the customer |
| | never leaves your site. |
| The merchant's webserver must be configured | Captures are automated |
| with a valid SSL certificate from an accepted | through the API, so you |
| Certificate Authority (CA). Note: self signed | don't need to perform |
| certificates, test certificates, and certificates | them manually through |
| from lesser known CAs are not supported. | the Merchant Support |
| Internet Explorer, including the 128-bit | Center website |
| encryption module which can be downloaded | |
| from www.microsoft.com. | |
| Open port 443 for https communication. | |
| Operation of the COM Plug through certain | |
| proxy servers is not supported. Ensure your | |
| proxy server is supported. | |
| Appropriate system access is required to | |
| register the COM Plug on the server. | |

TABLE 2
Plug Installation Instructions

1. Download COM Plug Installer
When you have downloaded the Com Plug Installer your system will be
setup with the following files:
<Selected Drive>\PayGateway\Prograrnming Examples
(contains directories with various programming examples).
<Selected Drive>\PayGateway\Sample Store
(contains sample ASP pages).
<Selected Drive>\<Windows Directory>\System32\PayGateway
(contains the PayGateway.dll file).
2. The COM Plug places sample files on your system to assist you in
integrating the COM Plug into your choice of several development
environments such as:

C/C++ Delphi Perl VB

or choose:

ASP Implementation PHP Implementation

3. Test your new payment pages by entering some transactions. The transactions will be passed to the financial gateway using a demo account token.

You should receive an Order Confirmation page indicating that the demo was successful.

Note: If your transaction fails, check that you have port 443 open. The plugs communicate via https on this port.

4. You are now ready to process live, real-time transactions on your merchant account. This is often called the “go live” stage of getting set up for online payment.

In order to go live with your new payment pages, you must have an approved Internet Merchant account and be activated to use Online Payment. If you haven't done so yet, follow the steps below.

>Contact your Financial Institution to apply for an Internet Merchant Account.

>Activate your new Internet Merchant Account so that you can accept online payments.

You will receive a “ReadyGo” e-mail containing the URL and User ID/password for the Merchant Support Center.

5. Use the Token Dispenser to obtain your unique account token.

You will be prompted for your Merchant Support Center User ID and password. Caution: Please keep your token secure! It contains a unique User ID and password.

6. Replace the demo account token on your pay page with your new token.

Note: Do not remove the word “TEST” from the beginning of the token string. It ensures that any transactions you send will not be passed to the bank for processing.

7. Send test transactions using your new token, following the instructions in the Testing Requirements.

8. Once you have successfully completed the testing requirements, you are now ready to process live transactions. If you have any questions, please call Merchant Services at 1.877.600.1717 (or outside North America +800 0600 1717) for help.

Back to Previous Page

With reference to FIG. 16, enterprise payment solutions are designed for large merchants and add value to CRM, ERP, and enterprise-level e-commerce software. These plug-ins securely route payment transactions from customers and suppliers through to the bank, helping enterprises to manage and synchronize financial interactions. AVS and CVV2 are provided as standard fraud prevention solutions and additional neural net fraud prevention services are preferably offered for a fee. The system 50 simplifies the movements to eCRM and ERP payments by providing highly demanded solutions such as SAP and Siebel. EBPP solutions are offered for B2C, B2B and small businesses.

The system preferably provides branded MIKs in several different languages, that is, pages in different languages (e.g., French, German and English) bearing the names and logos of the software product, the processor/acquirer, the certification company, among other vendors, most often recognized in that language. As with the MIK, branded versions of the merchant home page are also available in different languages to direct merchants to partners of the system provider (the system ) and no options are given for other providers.

As stated above, the MSC is a secure browser-based application that allows merchants to view all orders processed and transactions that have been attempted on their websites. The MSC is a database that stores the sellers' electronic transaction data and allows the seller to manage their business. The seller can review transactions, issue voids and refunds, close batches and monitor their electronic receipts.

The MSC provides merchants secure password-protected access to the aggregated data maintained in the system 50 about their transactions. Transactions reach the bank after they are settled. Merchants can settle transactions via the MSC automatically (e.g., once per day) when a batch is closed. Transactions can also be settled manually at any given time by the merchant via the MSC. Merchants can also use the MSC to select one or more orders for approval or sale, select one or more orders for deposit, find one or more orders or batches and generate reports (e.g., view daily batch totals).

With the MSC and its associated web pages, several options are available to a merchant to generate reports. For example, merchants can view orders, transactions, item sales statistics, sales tax and batches, as well as conduct merchant fraud protection, merchant reports administration and sales manager operations. Reports can be run to see transactions by card type to reconcile bank charges. Data can be exported into other applications.

By way of an example, orders can be selected and viewed by time, order number, or time and a card number or a user identifier. Orders can then be selected to perform various tasks such as confirm shipment, issue a refund or reject the order (e.g., reject orders from certain e-mail accounts or credit cards). Clicking on an order brings specific details to facilitate order management. Transactions can be viewed and managed. Details of batches can also be viewed. Prior to closing a batch, a transaction can be voided with ease. The sales manager can process different types of transactions refunds and pre-authorizations. The sales manager operates as a virtual POS for mail-order/telephone-order (MOTO) organizations.

The global integrated payment system 50 of the present invention is advantageous to merchants because it provides easy to use and fully supported tools that help them manage their payments needs. The system 50 benefits acquirers and other FIs because it supports bottom line improvements in e-commerce initiatives. For example, the system 50 improves customer acquisition by offering a wider range of pre-integrated and tested solutions with superior technical implementation support. The system 50 supports any type of merchant, large or small, with any type of commerce application. The system 50 improves customer retention by ensuring highly reliable and robust connections with superior ongoing customer service. The system 50 lowers costs by reducing the number of merchant connections that an acquirer or processor must implement, certify and support. The system 50 improves market responsiveness by reducing the amount of time and effort it takes to institute any changes to technical systems. Further, the system 50 eliminates the cost of having to build, maintain and enhance the tools required to support the new commerce applications and payment protocols that continue to emerge.

The system 50 is an ideal choice for providing Internet payment enablement and support to FIs merchants. The system provides proven, certified and robust connections to processors. The system 50 provides a wide portfolio of easy to use merchant tools that are updated to reflect the newest technology developments.

The specific needs of sellers vary greatly because sellers vary in terms of size, geographic scope, industry sector, technical ability, technological infrastructure, and payment type preference. The system 50 has a broad portfolio of solutions to meet these needs and allows sellers to use the Internet as the method for transmitting payment information generated from websites, call centers, point of sale, electronic bill presentment, mobile telephones and any other form of interface between the buyer and the seller. This means that sellers can have one solution that integrates all of their payment applications and all of their payment data. This makes the system 50 a more robust, easy-to-use and value-creating solution than other providers. In contrast to existing payment transaction tool providers, the system 50's Merchant Integration Kit is a differentiated tool for easily enabling new electronic payment technologies. Because the solutions available via the MIK and merchant home page of the system 50 are easy to implement, the need for technical support is greatly reduced. Ease of integration lowers the barriers to entry, allows more sellers to participate and creates a lower cost solution. The payment technology of the system is robust, scaleable, adaptable, and reliable. As the commerce management platform of the system 50 evolves (e.g., new payment types, software applications or banking relationships are added and as transaction volume increases), the system 50 adapts and incorporates the necessary solutions into one platform. In addition, the system 50 works with the solutions merchants and FIs already have in place and does not require merchants and FIs to change the products and solutions that they are satisfied with. The system 50 augments those solutions that FIs want to enhance and improve, allowing them to create a truly unique solution that only their organization can offer.

Although the present invention has been described with reference to a preferred embodiment thereof, it will be understood that the invention is not limited to the details thereof. Various modifications and substitutions will occur to those of ordinary skill in the art. All such substitutions are intended to be embraced within the scope of the invention as defined in the appended claims.

What is claimed is:

1. A system for aggregating payment transactions between merchants and financial institutions comprising:
a plurality of payment engines; and
a payment transaction manager configured to receive payment transactions from said merchants, to examine the protocols of said payment transactions to determine the transaction type, and to direct each of said payment transactions to one of said plurality of payment engines based on said transaction type.

2. A system as recited in claim 1, further comprising a database connected to said payment transaction manager, said payment transaction manager being operable to store transaction data relating to each of said payment transactions in said database.

3. A system as recited in claim 2, wherein said merchants can access said database and select and retrieve said transaction data therefrom.
